(19) United States
(12) Patent Application Publication
(10) Pub. No.: US 2020/0391459 A1
(43) Pub. Date: Dec. 17, 2020

(54) METHOD FOR PRODUCING POWER TRANSMISSION BELT

(71) Applicant: BANDO CHEMICAL INDUSTRIES, LTD., Kobe-shi (JP)

(72) Inventor: Toshiro OKAMOTO, Kobe-shi (JP)

(73) Assignee: BANDO CHEMICAL INDUSTRIES, LTD., Kobe-shi (JP)

(21) Appl. No.: 17/005,211

(22) Filed: Aug. 27, 2020

Related U.S. Application Data
(63) Continuation of application No. PCT/JP2019/038733, filed on Oct. 1, 2019.

(30) Foreign Application Priority Data
Nov. 22, 2018 (JP) 2018-219201

(51) Int. Cl. B29D 29/10; B32B 25/04; B32B 25/02

(52) U.S. Cl. CPC B29D 29/10; B32B 25/042; F16G 1/08; B32B 2433/04; B32B 25/02

(57) ABSTRACT

An uncrosslinked rubber shaped structure for belt production is placed in a belt mold with the uncrosslinked rubber shaped structure having a bent portion that is bent inward. A space inside the uncrosslinked rubber shaped structure is partitioned into a first space and a second space. The first space corresponds to a first shaped structure portion of the uncrosslinked rubber shaped structure, the first shaped structure portion including the bent portion. The second space corresponds to a second shaped structure portion of the uncrosslinked rubber shaped structure that is a portion of the uncrosslinked rubber shaped structure except the first shaped structure portion. An expansion member is expanded in the second space to press the second shaped structure portion toward the belt mold.

### CROSS-REFERENCE TO RELATED APPLICATIONS

This is a continuation of International Application No. PCT/JP2019/038733 filed on Oct. 1, 2019, which claims priority to Japanese Patent Application No. 2018-219201 filed on Nov. 22, 2018. The entire disclosures of these applications are incorporated by reference herein.

### BACKGROUND

The present invention relates to a method for producing a power transmission belt.

In a known method for producing a power transmission belt, a cylindrical uncrosslinked slab is placed inside a cylindrical belt mold, and the cylindrical uncrosslinked slab is heated and pressed from inside toward the belt mold, thereby crosslinking a rubber component to form a belt slab (e.g., Japanese Patent No. 6246420 and Japanese Patent No. 6230756).

### SUMMARY

An aspect of the present invention is directed to a method for producing a power transmission belt. The method includes: a first step of placing, in a cylindrical belt mold, a cylindrical uncrosslinked rubber shaped structure for belt production, with the uncrosslinked rubber shaped structure having a bent portion that is bent inward, and partitioning a space inside the uncrosslinked rubber shaped structure into a first space and a second space, the first space corresponding to a first shaped structure portion of the uncrosslinked rubber shaped structure, the first shaped structure portion including the bent portion, the second space corresponding to a second shaped structure portion of the uncrosslinked rubber shaped structure that is a portion of the uncrosslinked rubber shaped structure except the first shaped structure portion; and a second step of expanding an expansion member in the second space partitioned in the first step, so that the expansion member presses the second shaped structure portion toward the belt mold.

### BRIEF DESCRIPTION OF THE DRAWINGS

FIG. 1A is a drawing for explaining a first step in a method for producing a power transmission belt according to an embodiment.

FIG. 1B is a cross-sectional view taken along line IB-IB shown in FIG. 1A.

FIG. 2A is a perspective view illustrating how a bent portion of an uncrosslinked rubber shaped structure is formed.

FIG. 2B is a perspective view illustrating a state where the uncrosslinked rubber shaped structure has been inserted into a belt mold.

FIG. 2C is a drawing for explaining how the uncrosslinked rubber shaped structure that has just been inserted into the belt mold is elastically returned.

FIG. 3 is a drawing for explaining a variation of the first step in the method for protruding a power transmission belt according to the embodiment.

FIG. 4A is a first drawing for explaining a second step in the method for producing a power transmission belt according to the embodiment.

FIG. 4B is a cross-sectional view taken along line IVB-IVB shown in FIG. 4A.

FIG. 5A is a second drawing for explaining the second step in the method for producing a power transmission belt according to the embodiment.

FIG. 5B is a cross-sectional view taken along line VB-VB shown in FIG. 5A.

FIG. 6 is a perspective view of a piece of a flat belt.

FIG. 7A is a first drawing for explaining a shaping step in a method for producing the flat belt.

FIG. 7B is a second drawing for explaining the shaping step in the method for producing the flat belt.

FIG. 7C is a third drawing for explaining the shaping step in the method for producing the flat belt.

FIG. 8A is a cross-sectional view of a crosslinking apparatus.

FIG. 8B shows, on an enlarged scale, a cross section of a portion of the crosslinking apparatus.

FIG. 9A is a first drawing for explaining a crosslinking step in the method for producing the flat belt.

FIG. 9B is a second drawing for explaining the crosslinking step in the method for producing the flat belt.

FIG. 9C is a third drawing for explaining the crosslinking step in the method for producing the flat belt.

FIG. 10 is a perspective view of a piece of a V-ribbed belt.

FIG. 11 is a drawing for explaining a shaping step in a method for producing the V-ribbed belt.

FIG. 12A is a first drawing for explaining a crosslinking step in the method for producing the V-ribbed belt.

FIG. 12B is a second drawing for explaining the crosslinking step in the method for producing the V-ribbed belt.

FIG. 12C is a third drawing for explaining the crosslinking step in the method for producing the V-ribbed belt.

FIG. 13A is a drawing for explaining a shaping step in a method for producing a V-ribbed belt according to a variation.

FIG. 13B is a perspective view of a piece of the V-ribbed belt according to the variation.

FIG. 14A is a drawing for explaining a shaping step in a method for producing a V-ribbed belt according to another variation.

FIG. 14B is a perspective view of a piece of the V-ribbed belt according to the another variation.

FIG. 15A is a first drawing for explaining a variation of the shaping step in the method for producing the V-ribbed belt.

FIG. 15B is a second drawing for explaining the variation of the shaping step in the method for producing the V-ribbed belt.

FIG. 16A is a perspective view of a piece of a raw edge V-belt.

FIG. 16B is a perspective view of a piece of a V-belt having a pulley contact surface covered with a reinforcing fabric.

### DETAILED DESCRIPTION

Embodiments will be described in detail below with reference to the drawings.

A method for producing a power transmission belt according to an embodiment includes the following first and second steps.

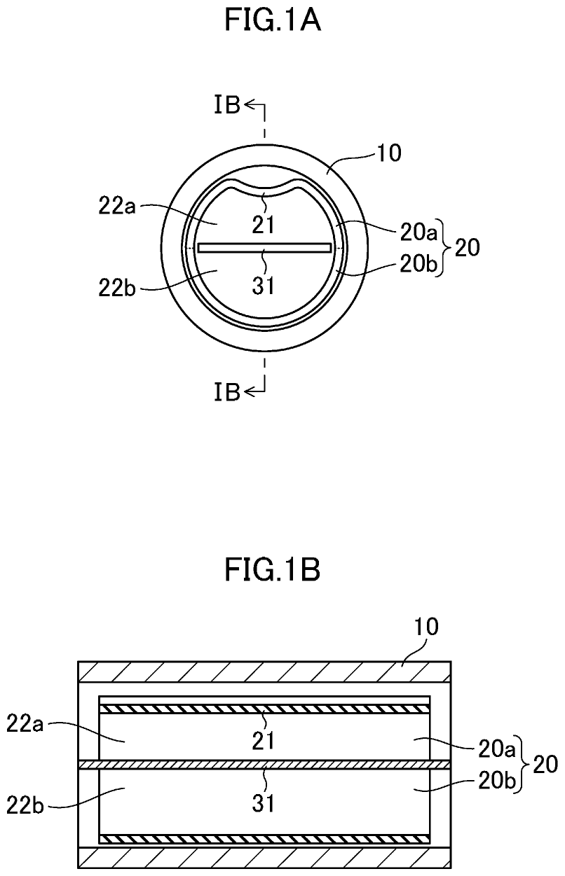

In the first step, as shown in FIGS. 1A and 1B, a cylindrical uncrosslinked rubber shaped structure 20 for belt production is placed in a cylindrical belt mold 10, with the uncrosslinked rubber shaped structure 20 having a bent portion 21 that is bent inward. Further, a space inside the uncrosslinked rubber shaped structure 20 is partitioned into a first space 22a and a second space 22b. The first space 22a corresponds to a first shaped structure portion 20a of the uncrosslinked rubber shaped structure 20, the first shaped structure portion 20a including the bent portion 21. The second space 22b corresponds to a second shaped structure portion 20b of the uncrosslinked rubber shaped structure 20 that is a portion of the uncrosslinked rubber shaped structure 20 except the first shaped structure portion 20a.

The belt mold 10 is merely an example, and is configured as a cylindrical mold in one preferred embodiment. The belt mold 10 is selected depending on the type of a power transmission belt to be produced. Specifically, if a flat belt is to be produced, a belt mold 10 having a smooth inner peripheral surface is used. If a V-belt or a V-ribbed belt is to be produced, a belt mold 10 having, on its inner peripheral surface, grooves extending in a circumferential direction and arranged adjacent to one another in an axial direction is used. If a toothed belt is to be produced, a belt mold 10 having, on its inner peripheral surface, grooves extending in the axial direction and arranged at intervals in the circumferential direction is used. The inner peripheral length of the belt mold 10 corresponds to the size of the power transmission belt to be produced, and ranges, for example, from 500 mm to 3000 mm. The inner peripheral length of the belt mold 10 as used herein defines the length of the perimeter of a circle having a diameter equal to the maximum inside diameter of the belt mold 10.

The uncrosslinked rubber shaped structure 20 may be an uncrosslinked slab that includes: a cylindrical shaped structure body made of an uncrosslinked rubber composition; a cord extending so as to form a helical pattern with pitches in the axial direction of the shaped structure body and embedded in the shaped structure body; and, as necessary, a reinforcing fabric stacked on an outer peripheral surface and/or an inner peripheral surface of the shaped structure body. Alternatively, the uncrosslinked rubber shaped structure 20 may be a slab component that forms a portion of the uncrosslinked slab. The outer peripheral length of the uncrosslinked rubber shaped structure 20 is slightly shorter than the inner peripheral length of the belt mold 10. The outer peripheral length of the uncrosslinked rubber shaped structure 20 as used herein defines the length of the perimeter of a circle having a diameter equal to the maximum outer diameter of a circle defined by the uncrosslinked rubber shaped structure 20 as viewed axially.

The uncrosslinked rubber shaped structure 20 is formed depending on the type of the power transmission belt to be produced. Specifically, if a flat belt is to be produced, an uncrosslinked rubber shaped structure 20 having a smooth outer peripheral surface is formed. If a V-belt or a V-ribbed belt is to be produced, an uncrosslinked rubber shaped structure 20 having, on its outer peripheral surface, ridges respectively corresponding to the grooves of the belt mold 10 is formed. The ridges extend in a circumferential direction of the uncrosslinked rubber shaped structure 20, and are arranged adjacent to one another in an axial direction of the uncrosslinked rubber shaped structure 20. If a toothed belt is to be produced, an uncrosslinked rubber shaped structure 20 having, on its outer peripheral surface, ridges respectively corresponding to the grooves of the belt mold 10 is formed. The ridges extend in the axial direction, and are arranged adjacent to one another in the circumferential direction.

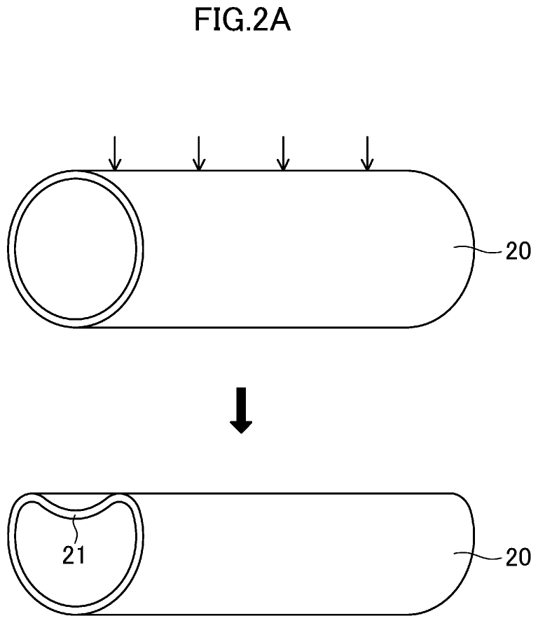

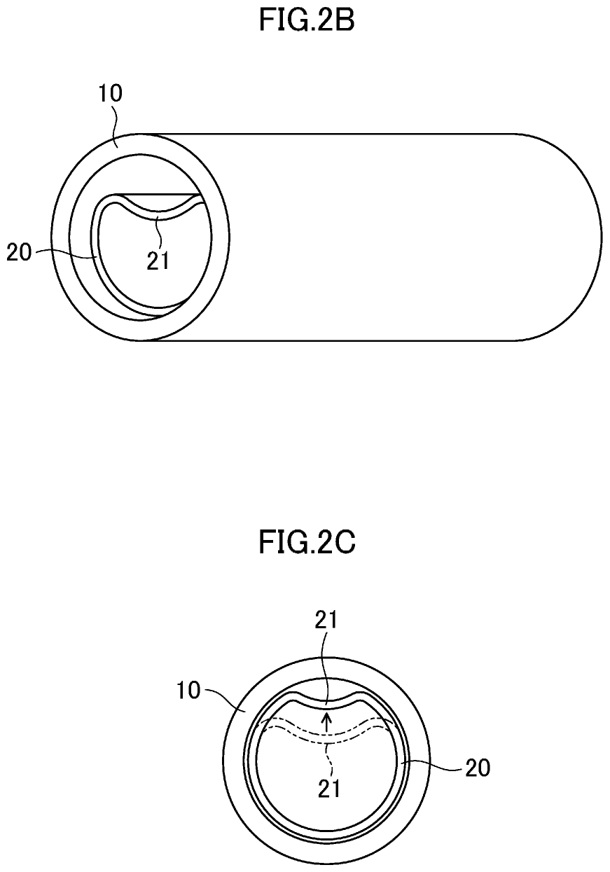

To place the uncrosslinked rubber shaped structure 20 inside the belt mold 10, the cylindrical uncrosslinked rubber shaped structure 20 is first formed so as to have a heart-shaped cross section as shown in FIG. 2A such that the cylindrical uncrosslinked rubber shaped structure 20 has a bent portion 21 that is bent inward along the length of the uncrosslinked rubber shaped structure 20. Next, as shown in FIG. 2B, the uncrosslinked rubber shaped structure 20 having the heart-shaped cross section is inserted into the belt mold 10 without changing its shape Immediately after the insertion into the belt mold 10, the amount of bending of the bent portion 21 decreases due to elastic return of the bent portion 21 as shown in FIG. 2C. The other portion than the bent portion 21 of the uncrosslinked rubber shaped structure 20 inserted into the belt mold 10 includes, while being along the inner periphery of the belt mold 10, a portion that comes into contact with the inner peripheral surface of the belt mold 10 and a portion having clearance from the inner peripheral surface of the belt mold 10.

In one preferred embodiment, a partition member 31 inserted into the belt mold 10 partitions the space inside the uncrosslinked rubber shaped structure 20 into the first space 22a and the second space 22b. The partition member 31 is merely an example, and is configured as a flat plate member in one preferred embodiment. To improve the ease of inserting the uncrosslinked rubber shaped structure 20 into the belt mold 10, the partition member 31 is inserted into the belt mold 10 after the uncrosslinked rubber shaped structure 20 is inserted into the belt mold 10 and positioned, in one preferred embodiment. Note that the partition member 31 may be previously inserted into the belt mold 10 before insertion of the uncrosslinked rubber shaped structure 20. In this case, the uncrosslinked rubber shaped structure 20 is inserted into the belt mold 10 in which the partition member 31 has been placed. Alternatively, the partition member 31 and the uncrosslinked rubber shaped structure 20 may be inserted into the belt mold 10 at the same time.

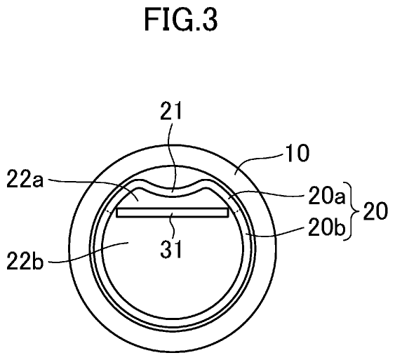

To place the uncrosslinked rubber shaped structure 20 along the entire inner periphery of the belt mold 10 as described below, the partition member 31 partitions the space inside the uncrosslinked rubber shaped structure 20 into the first and second spaces 22a and 22b such that the length of the first shaped structure portion 20a of the uncrosslinked rubber shaped structure 20 is shorter than or equal to the length of the second shaped structure portion 20b of the uncrosslinked rubber shaped structure 20 in one preferred embodiment. Specifically, in one preferred embodiment, the partition member 31 is positioned such that as shown in FIGS. 1A and 1B, the length of the first shaped structure portion 20a corresponding to the first space 22a is equal to the length of the second shaped structure portion 20b corresponding to the second space 22b, or such that as shown in FIG. 3, the length of the first shaped structure portion 20a is shorter than the length of the second shaped structure portion 20b. To prevent damage on the uncrosslinked rubber shaped structure 20, in one preferred embodiment, the partition member 31 is positioned so as not to be in contact with the uncrosslinked rubber shaped structure 20, that is, such that the first and second spaces 22a and 22b communicate with each other. If the partition member 31 is in the shape of a flat plate, clearance between a lateral end of the flat plate-shaped partition member 31 and the uncrosslinked rubber shaped structure 20 ranges from 1 mm to 5 mm, for example.

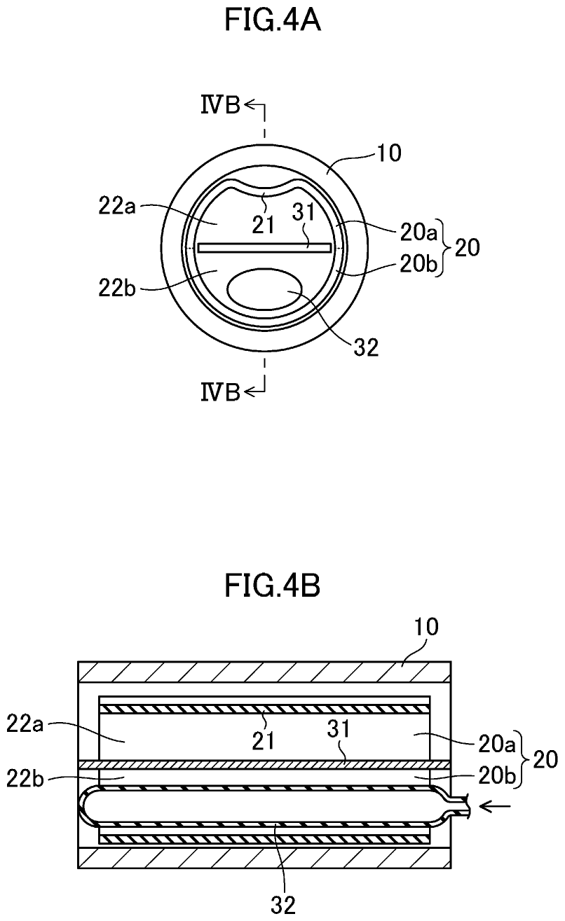

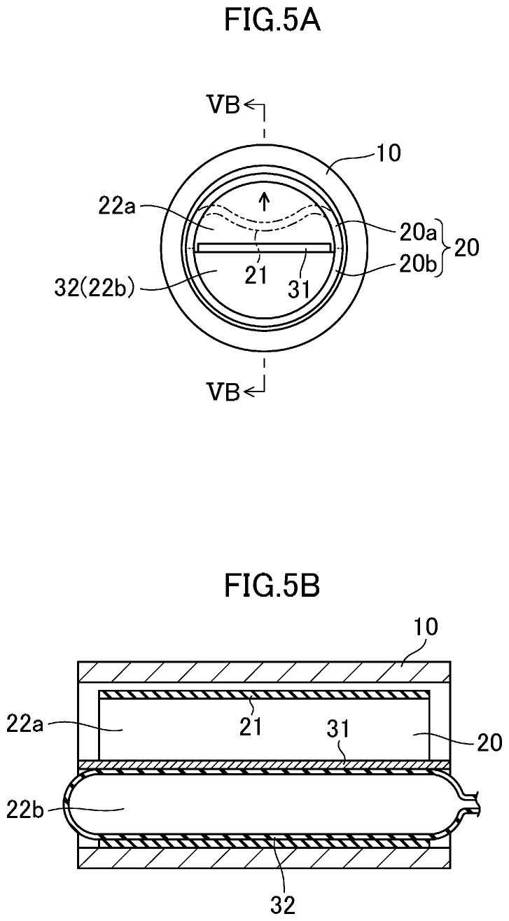

In the second step, an expansion member 32 is placed in the second space 22b as shown in FIGS. 4A and 4B. The expansion member 32 is expanded to press the second shaped structure portion 20b toward the belt mold 10 as shown in FIGS. 5A and 5B.

The expansion member 32 is merely an example, and is configured as a balloon member made of rubber in one preferred embodiment. In one preferred embodiment, to insert the expansion member 32 in the belt mold 10, the uncrosslinked rubber shaped structure 20 and the partition member 31 are inserted into the belt mold 10 first, and then the expansion member 32 is inserted in the second space 22b, defined by the partition member 31, in the interior space of the uncrosslinked rubber shaped structure 20 placed in the belt mold 10.

The expansion member 32, when expanded in the second space 22b, occupies the second space 22b, and comes into contact with the inner surface of the second shaped structure portion 20b to press the second shaped structure portion 20b toward the belt mold 10. This allows the second shaped structure portion 20b to be in tight contact with the belt mold 10, thus reducing or eliminating clearance therebetween. On the other hand, in the first space 22a, clearance between the belt mold 10 and the first shaped structure portion 20a increases, and the bent portion 21 is pulled from both sides to expand outward, and thus elastically returns. Thus, the portion that used to be the bent portion 21 is now along the inner periphery of the belt mold 10, and the uncrosslinked rubber shaped structure 20 is positioned along the entire inner periphery of the belt mold 10.

In placing a cylindrical uncrosslinked slab in a cylindrical belt mold, the uncrosslinked slab is inserted in the belt mold while being bent inward to have a heart-shaped cross section, if the inner peripheral length of the belt mold is sufficiently longer than the outer peripheral length of the uncrosslinked slab. This bent portion elastically returns, and the uncrosslinked slab is arranged along the entire inner periphery of the belt mold. Even if the uncrosslinked slab that is bent to have the heart-shaped cross section is inserted in the belt mold, the bent portion does not elastically return in a sufficient manner and the uncrosslinked slab is not arranged along the entire inner periphery of the belt mold, if the difference between the inner peripheral length of the belt mold and the outer peripheral length of the uncrosslinked slab is small.

However, in the method for producing a power transmission belt according to the embodiment described above, the bent portion 21 can elastically return and the cylindrical uncrosslinked rubber shaped structure 20 can be arranged along the entire inner periphery of the cylindrical belt mold 10, even if the difference between the inner peripheral length of the belt mold 10 and the outer peripheral length of the uncrosslinked rubber shaped structure 20 is small. This is achieved by: placing, in the cylindrical belt mold 10, the cylindrical uncrosslinked rubber shaped structure 20 for belt production, with the uncrosslinked rubber shaped structure 20 having the bent portion 21 that is bent inward; partitioning the space inside the uncrosslinked rubber shaped structure 20 into the first space 22a corresponding to the first shaped structure portion 20a of the uncrosslinked rubber shaped structure 20, the first shaped structure portion 20a including the bent portion 21, and the second space 22b corresponding to the second shaped structure portion 20b of the uncrosslinked rubber shaped structure 20 that is a portion except the first shaped structure portion 20a; and expanding the expansion member 32 in the second space 22b so that the expansion member 32 presses the second shaped structure portion 20b toward the belt mold 10.

The elastic return of the bent portion 21 is inhibited if the difference between the inner peripheral length of the belt mold 10 and the outer peripheral length of the uncrosslinked rubber shaped structure 20 is small. Thus, such advantages are significant particularly in a case in which the difference between the inner peripheral length of the belt mold 10 and the outer peripheral length of the uncrosslinked rubber shaped structure 20 is less than or equal to 0.5% of the outer peripheral length of the uncrosslinked rubber shaped structure 20.

Furthermore, the elastic return of the bent portion 21 is inhibited if the uncrosslinked rubber shaped structure 20 has high rigidity. Thus, such advantages are significant particularly in a case in which the uncrosslinked rubber shaped structure 20 is an uncrosslinked slab that includes: a cylindrical shaped structure body made of an uncrosslinked rubber composition; and a cord made of aramid fibers, the cord extending so as to form a helical pattern with pitches in an axial direction and embedded in the shaped structure body.

Subsequently, in the method for producing a power transmission belt according to the embodiment, the expansion member 32 is contracted and removed from the belt mold 10 together with the partition member 31. Then, the uncrosslinked slab including the uncrosslinked rubber shaped structure 20 placed inside the belt mold 10 is heated and pressed toward the belt mold 10, thereby crosslinking the uncrosslinked rubber composition so that the resultant rubber composition is combined with a cord and a reinforcing fabric to form a cylindrical belt slab. This belt slab is cut into ring-shaped pieces having a predetermined width to obtain a power transmission belt.

A method for producing each of a flat belt and a V-ribbed belt by the method for producing a power transmission belt according to the embodiment will now be specifically described.

(Method for Producing Flat Belt)

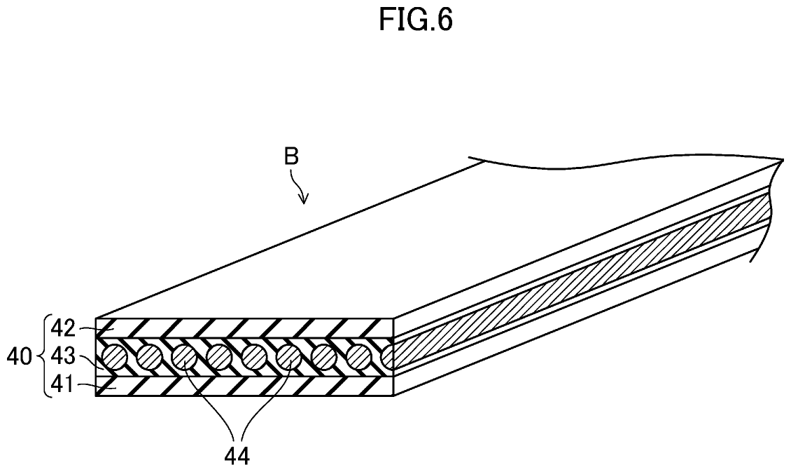

FIG. 6 shows a flat belt B. The flat belt B includes a rubber belt body 40 including a compressed rubber layer 41 forming an inner portion in the thickness direction, a stretch rubber layer 42 forming an outer portion, and an adhesive rubber layer 43 provided between the compressed rubber layer 41 and the stretch rubber layer 42. A cord 44 is embedded in a middle portion, in the thickness direction, of the adhesive rubber layer 43. The cord 44 forms, in the adhesive rubber layer 43, a helical pattern having pitches in the width direction.

The compressed rubber layer 41, the stretch rubber layer 42, and the adhesive rubber layer 43 are each made of a crosslinked rubber composition which is produced through heating and pressing of an uncrosslinked rubber composition prepared by kneading a blend of a rubber component and various compound ingredients.

Examples of the rubber component include ethylene-α-olefin elastomer (such as EPDM and EPR), chloroprene rubber (CR), chlorosulfonated polyethylene rubber (CSM), and hydrogenated acrylonitrile-butadiene rubber (H-NBR). In one preferred embodiment, the rubber component contains one kind or a blend of two or more kinds of these substances. Examples of the compound ingredients include a reinforcing material (such as carbon black), a filler, a plasticizer, a processing aid, a crosslinking agent, a co-crosslinking agent, a vulcanization accelerator, a vulcanization accelerator aid, and an antioxidant. The cord 44 is made of a twisted yarn of fibers, such as polyester fibers, polyethylene naphthalate fibers, aramid fibers, and vinylon fibers. The cord 44 has undergone an adhesion treatment to be adhesive to the adhesive rubber layer 43 of the belt body 40.

A process for producing the flat belt B includes a component preparation step, a shaping step, a crosslinking step, and a finishing step.

<Component Preparation Step>

In the component preparation step, a compressed rubber sheet 41′ which is to constitute a compressed rubber layer 41, a stretch rubber sheet 42′ which is to constitute a stretch rubber layer 42, an adhesive rubber sheet 43′ which is to constitute an adhesive rubber layer 43, and a cord 44′ are prepared.

A rubber component and compound ingredients are kneaded together by using a kneading machine such as a kneader or a Banbury mixer to obtain an uncrosslinked rubber composition. The uncrosslinked rubber composition is molded by calendar molding or the like, into sheets, i.e., the compressed rubber sheet 41′, the stretch rubber sheet 42′, and the adhesive rubber sheet 43′.

A twisted yarn to form a cord 44 undergoes an adhesion treatment in which the twisted yarn is soaked in an RFL aqueous solution and heated, and/or an adhesion treatment in which the twisted yarn is soaked in rubber cement and dried. The twisted yarn may undergo, prior to these adhesion treatments, a base treatment in which the twisted yarn is soaked in an epoxy resin solution or an isocyanate resin solution and heated.

<Shaping Step>

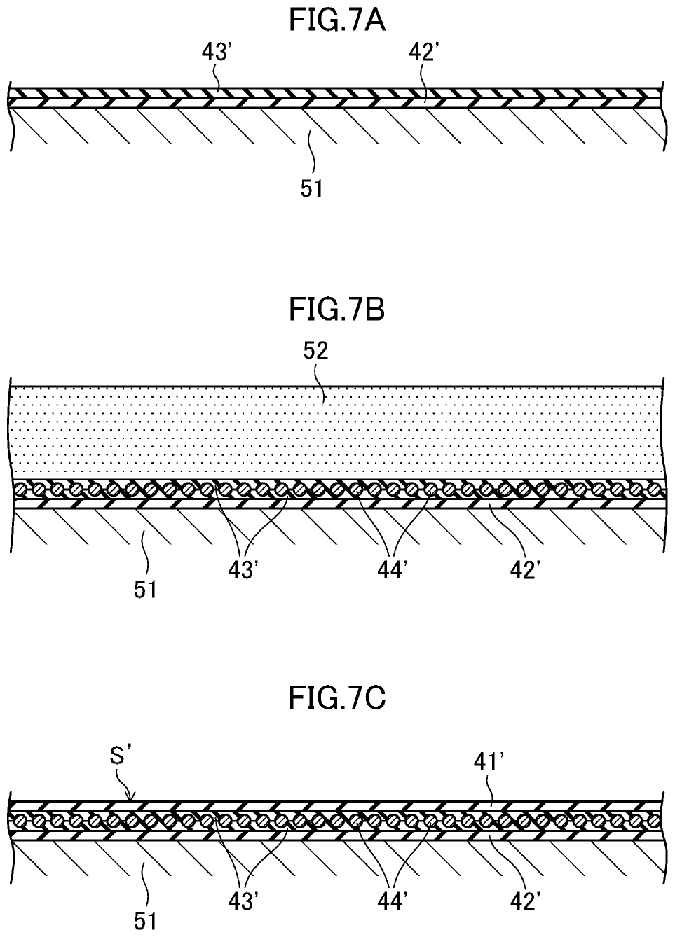

In the shaping step, first, a shaping mandrel 51 having a cylindrical shape is rotatably supported on a shaft of a shaping machine (not shown) such that the axis of the shaping mandrel 51 extends horizontally. As shown in FIG. 7A, the stretch rubber sheet 42′ and the adhesive rubber sheet 43′ are sequentially wrapped around the shaping mandrel 51 to form a layered structure.

Subsequently, as shown in FIG. 7B, the cord 44′ is helically wound around the adhesive rubber sheet 43′. Another adhesive rubber sheet 43′ is then wrapped over the wound cord 44′ to form another layered structure, which is pressed by a roller 52. At this moment, the rubber flows and enters between turns of the cord 44′, and the cord 44′ is embedded between the pair of adhesive rubber sheets 43′.

Then, as shown in FIG. 7C, the compressed rubber sheet 41′ is wrapped around the adhesive rubber sheet 43′, thereby forming an uncrosslinked slab S′. The uncrosslinked slab S′ thus obtained has a smooth outer peripheral surface.

The compressed rubber sheet 41′, the stretch rubber sheet 42′, and the adhesive rubber sheet 43′ are cut with an ultrasound cutter, air scissors, or the like, and both cut ends are lap jointed together.

<Crosslinking Step>

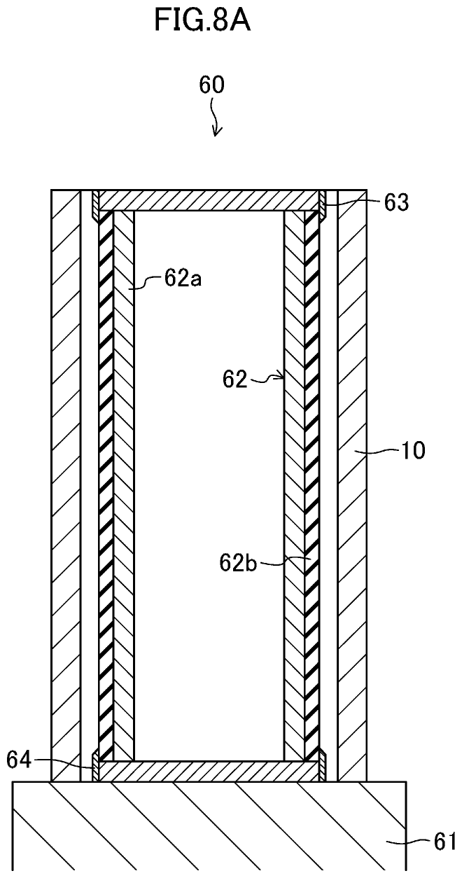

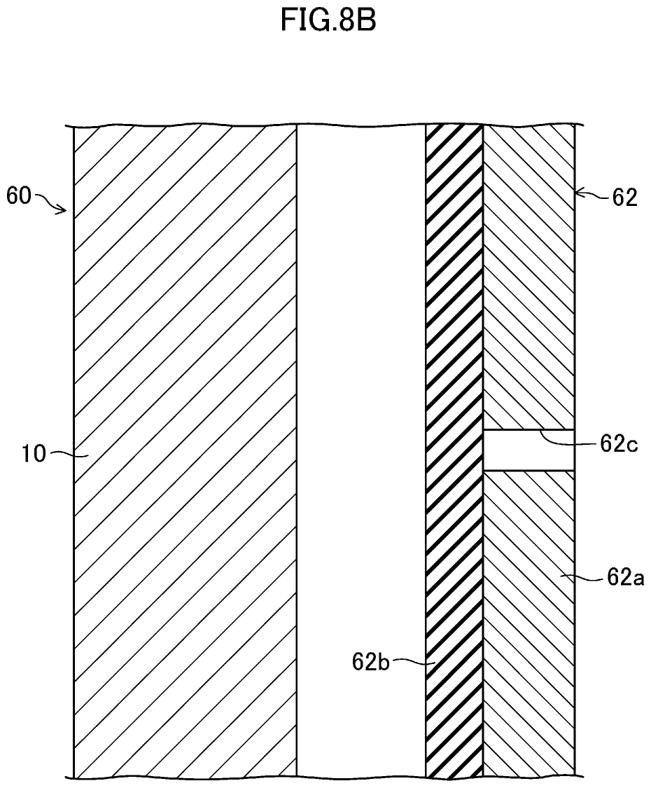

FIGS. 8A and 8B illustrate a crosslinking apparatus 60 for use in a crosslinking step. The crosslinking apparatus 60 includes a base 61, a columnar expansion drum 62 standing on the base 61, a cylindrical belt mold 10 provided outside the expansion drum 62.

The expansion drum 62 includes a drum body 62a having a hollow columnar shape, and a cylindrical expansion sleeve 62b made of rubber and externally fitted over the outer periphery of the drum body 62a. The drum body 62a has, in its peripheral wall, a large number of air-passage holes 62c communicating with the inside. A space between the expansion sleeve 62b and the drum body 62a is sealed by fixing rings 63 and 64 at both ends of the expansion sleeve 62b and the drum body 62a. The crosslinking apparatus 60 includes a pressurizing means (not shown) for applying a pressure by introducing high-pressure air into the drum body 62a. The high-pressure air introduced into the drum body 62a by the pressurizing means passes through the air-passage holes 62c to enter the space between the drum body 62a and the expansion sleeve 62b, and inflates the expansion sleeve 62b radially outward.

The belt mold 10 is attachable to, and detachable from, the base 61. The belt mold 10 is attached to the base 61 such that the belt mold 10 and the expansion drum 62 are arranged concentrically with each other with a space interposed therebetween. The belt mold 10 has a smooth inner peripheral surface. The crosslinking apparatus 60 includes a heating means and a cooling means (both are not shown) for the belt mold 10, so that the temperature of the belt mold 10 can be controlled by these heating and cooling means.

In the crosslinking step, the uncrosslinked slab S′ is removed from the shaping mandrel 51, and then, placed along the entire inner periphery of the belt mold 10, which has been previously detached from the base 61 of the crosslinking apparatus 60. At this moment, the uncrosslinked slab S′ is used as the uncrosslinked rubber shaped structure 20. As shown in FIGS. 1A and 1B to FIGS. 5A and 5B, the uncrosslinked rubber shaped structure 20 is placed in the belt mold 10, with the uncrosslinked rubber shaped structure 20 having the bent portion 21 that is bent inward. Further, the space inside the uncrosslinked rubber shaped structure 20 is partitioned into the first space 22a and the second space 22b. The first space 22a corresponds to the first shaped structure portion 20a of the uncrosslinked rubber shaped structure 20, the first shaped structure portion 20a including the bent portion 21. The second space 22b corresponds to the second shaped structure portion 20b of the uncrosslinked rubber shaped structure 20 that is a portion of the uncrosslinked rubber shaped structure except the first shaped structure portion 20a. The expansion member 32 is expanded in the second space 22b so that the expansion member 32 presses the second shaped structure portion 20b toward the belt mold 10 and that the uncrosslinked rubber shaped structure 20 is arranged along the entire inner periphery of the belt mold 10.

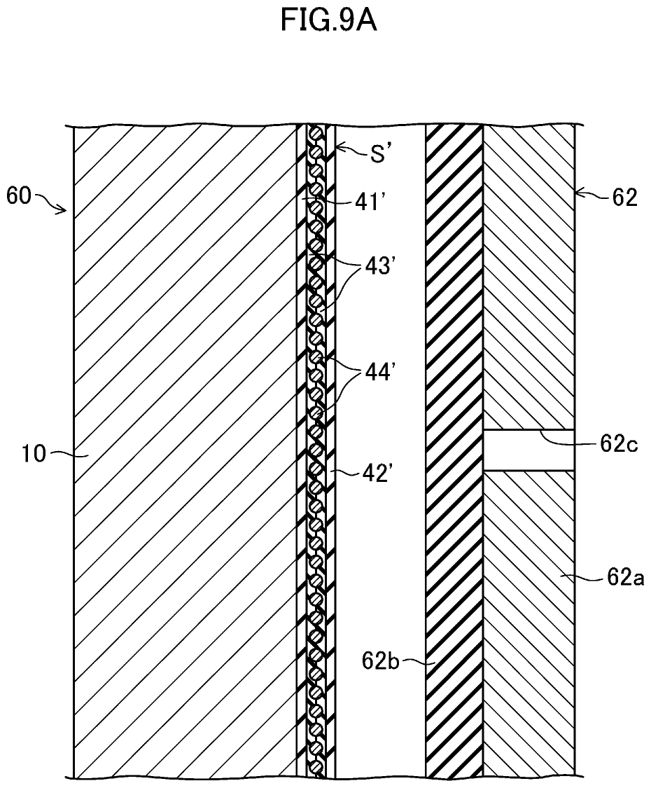

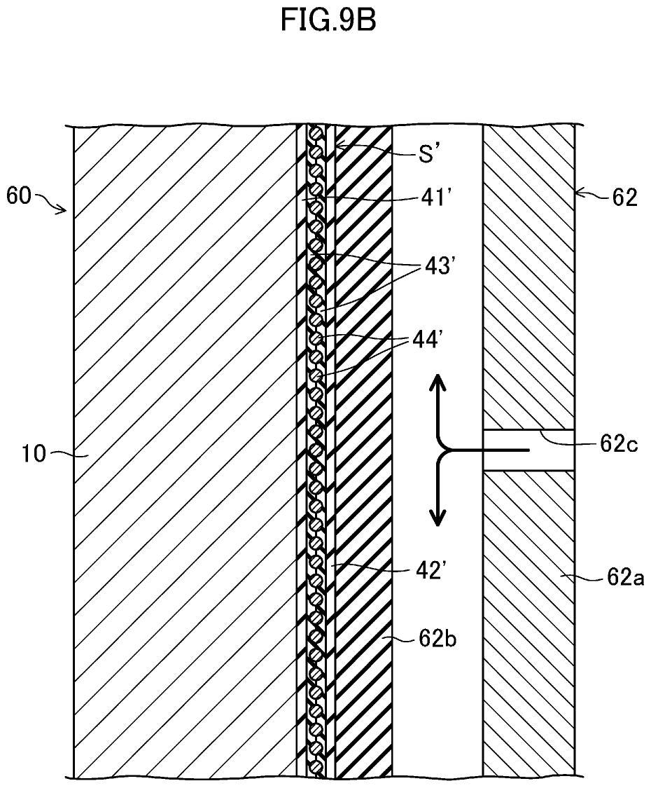

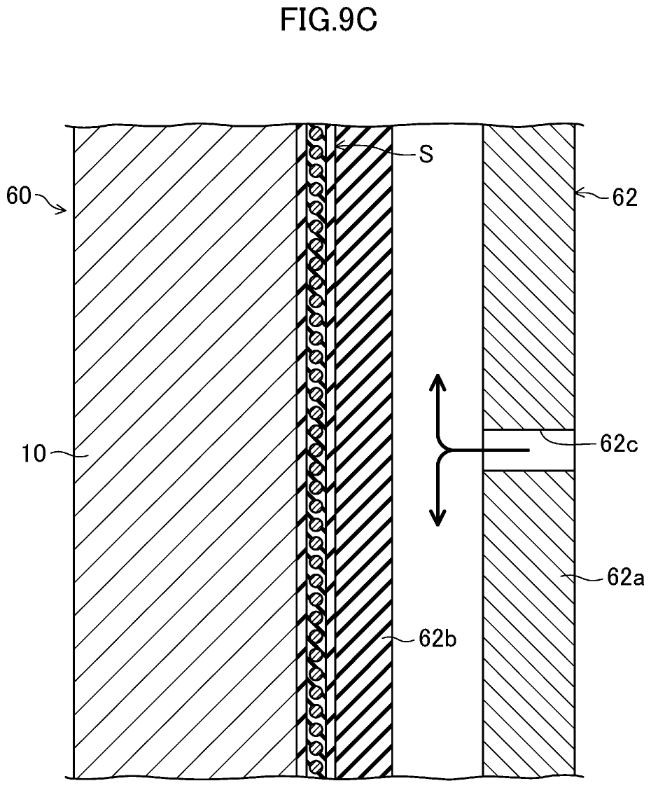

Subsequently, after the expansion member 32 is contracted and removed from the belt mold 10 together with the partition member 31, the belt mold 10 within which the uncrosslinked slab S′ has been set is attached to the base 61 such that the belt mold 10 covers the expansion drum 62 as shown in FIG. 9A.

As shown in FIG. 9B, the temperature of the belt mold 10 is increased by the heating means, and the pressurizing means introduces high-pressure air into the drum body 62a of the expansion drum 62 so as to expand the expansion sleeve 62b radially outward. This state is maintained for a predetermined period of time. At this moment, the uncrosslinked slab S′ is heated by the belt mold 10, and is pressed toward the belt mold 10 by the expansion sleeve 62b. The rubber components contained in the compressed rubber sheet 41′, the stretch rubber sheet 42′, and the adhesive rubber sheet 43′ that are included in the uncrosslinked slab S′ are crosslinked and integrated with one another. As a result, a continuous structure of belt bodies 40 for a plurality of flat belts B is produced. The rubber components adhere to, and are combined with, the cord 44′. A cylindrical belt slab S is thus formed eventually as shown in FIG. 9C.

<Finishing Step>

In a finishing step, the pressure inside the drum body 62a applied by the pressurizing means is released. After the belt mold 10 is cooled by the cooling means, the belt mold 10 is detached from the base 61, and the belt slab S that has been formed in the belt mold 10 is removed from the belt mold 10. The belt slab S that has been removed from the belt mold 10 is cut into ring-shaped pieces having a predetermined width. Each piece is turned inside out, thereby obtaining the flat belt B.

(Method for Producing V-Ribbed Belt)

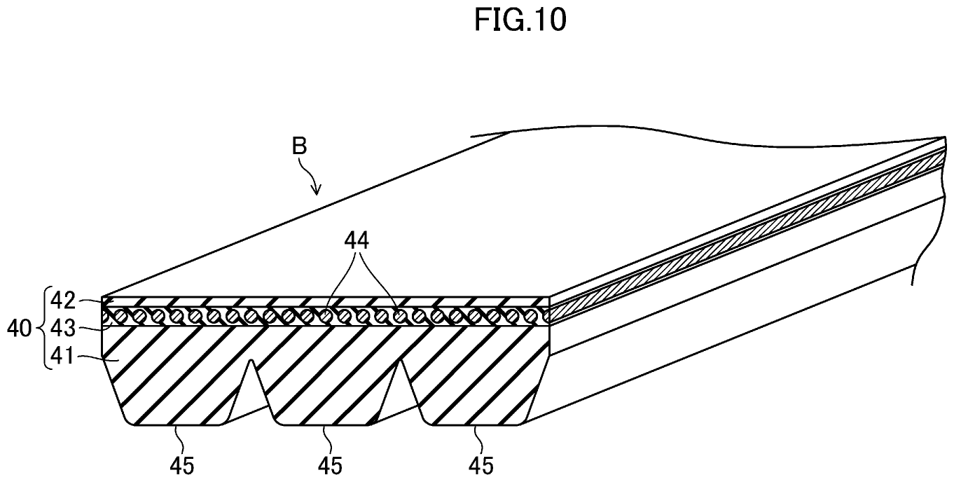

FIG. 10 illustrates a V-ribbed belt B. Just like the flat belt B, the V-ribbed belt B includes a rubber belt body 40 including a compressed rubber layer 41, a stretch rubber layer 42, and an adhesive rubber layer 43. A cord 44 is embedded in a middle portion, in the thickness direction, of the adhesive rubber layer 43 of the belt body 40. The compressed rubber layer 41 is provided with a plurality of V-shaped ribs 45 configured as ridges extending in the belt length direction. Rubber compositions respectively forming the compressed rubber layer 41, the stretch rubber layer 42, and the adhesive rubber layer 43 are similar to those of the flat belt B. However, the rubber composition forming the compressed rubber layer 41 may contain a surface texture modifier, such as short fibers, fluororesin powder, polyethylene resin powder, hollow particles, or a foaming agent. The twisted yarn constituting the cord 44 is similar to that of the flat belt B.

A process for producing the V-ribbed belt B includes a component preparation step, a shaping step, a crosslinking step, and a finishing step.

<Component Preparation Step>

In the component preparation step, a compressed rubber sheet 41′ which is to constitute a compressed rubber layer 41, a stretch rubber sheet 42′ which is to constitute a stretch rubber layer 42, an adhesive rubber sheet 43′ which is to constitute an adhesive rubber layer 43, and a cord 44′ are prepared.

An extruder is used to knead a rubber component and compound ingredients together and prepare, by extrusion molding, the compressed rubber sheet 41′ having, on one of the surfaces, a plurality of V-shaped rib-forming portions 45′, which are ridges extending linearly in the direction of the extrusion and are arranged adjacent to one another in parallel. A method for producing a compressed rubber sheet 41′ having such a configuration is disclosed also in Japanese Patent No. 6246420 and Japanese Patent No. 6230756.

A rubber component and compound ingredients are kneaded together by using a kneading machine such as a kneader or a Banbury mixer to obtain an uncrosslinked rubber composition. The uncrosslinked rubber composition is molded by calendar molding or the like, into sheets, i.e., the stretch rubber sheet 42′ and the adhesive rubber sheet 43′.

Further, a twisted yarn to form a cord 44 undergoes an adhesion treatment in which the twisted yarn is soaked in an RFL aqueous solution and heated, and/or an adhesion treatment in which the twisted yarn is soaked in rubber cement and dried. The twisted yarn may undergo, prior to these adhesion treatments, a base treatment in which the twisted yarn is soaked in an epoxy resin solution or an isocyanate resin solution and heated.

<Shaping Step>

In the shaping step, first, a shaping mandrel 51 having a cylindrical shape is rotatably supported on a shaft of a shaping machine (not shown) such that the axis of the shaping mandrel 51 extends horizontally. Similarly to the case of the flat belt B, the stretch rubber sheet 42′ and the adhesive rubber sheet 43′ are sequentially wrapped around the shaping mandrel 51 to form a layered structure.

Subsequently, the cord 44′ is helically wound around the adhesive rubber sheet 43′. Another adhesive rubber sheet 43′ is then wrapped over the wound cord 44′ to form another layered structure, which is pressed by a roller. At this moment, the rubber flows and enters between turns of the cord 44′, and the cord 44′ is embedded between the pair of adhesive rubber sheets 43′.

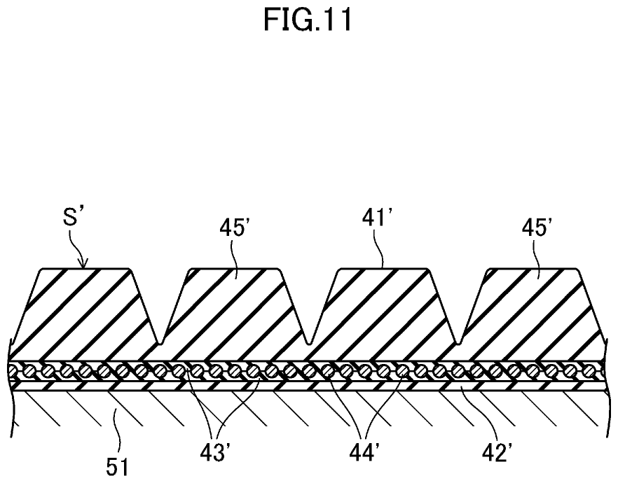

Then, as shown in FIG. 11, the compressed rubber sheet 41′ is wrapped around the adhesive rubber sheet 43′ such that the V-shaped rib-forming portions 45′ face outside and extend in the circumferential direction, thereby forming an uncrosslinked slab S′. The uncrosslinked slab S′ thus obtained has, on its outer peripheral surface, a plurality of V-shaped rib-forming portions 45′, which are ridges extending in the circumferential direction and arranged adjacent to one another in parallel.

The compressed rubber sheet 41′, the stretch rubber sheet 42′, and the adhesive rubber sheet 43′ are cut with an ultrasound cutter, air scissors, or the like, and both cut ends are lap jointed together.

<Crosslinking Step>

A crosslinking apparatus 60 for use to produce the V-ribbed belt B has a configuration similar to that of the crosslinking apparatus 60 for use to produce the flat belt B, except that the inner peripheral surface of the belt mold 10 has a plurality of V-shaped rib formation grooves 11 extending in the circumferential direction and arranged adjacent to one another in the axial direction.

In the crosslinking step, the uncrosslinked slab S′ is removed from the shaping mandrel 51, and then, placed along the entire inner periphery of the belt mold 10, which has been previously detached from the base 61 of the crosslinking apparatus 60. At this moment, the uncrosslinked slab S′ is used as the uncrosslinked rubber shaped structure 20. As shown in FIGS. 1A and 1B to FIGS. 5A and 5B, the uncrosslinked rubber shaped structure 20 is placed in the belt mold 10, with the uncrosslinked rubber shaped structure 20 having the bent portion 21 that is bent inward. Further, the space inside the uncrosslinked rubber shaped structure 20 is partitioned into the first space 22a and the second space 22b. The first space 22a corresponds to the first shaped structure portion 20a of the uncrosslinked rubber shaped structure 20, the first shaped structure portion 20a including the bent portion 21. The second space 22b corresponds to the second shaped structure portion 20b of the uncrosslinked rubber shaped structure 20 that is a portion of the uncrosslinked rubber shaped structure except the first shaped structure portion 20a. The expansion member 32 is expanded in the second space 22b so that the expansion member 32 presses the second shaped structure portion 20b toward the belt mold 10 and that the uncrosslinked rubber shaped structure 20 is arranged along the entire inner periphery of the belt mold 10. The V-shaped rib-forming portions 45′ of the outer peripheral surface of the uncrosslinked slab S′ are each moved, or fitted, into an associated one of the V-shaped rib formation grooves 11 on the inner peripheral surface of the belt mold 10.

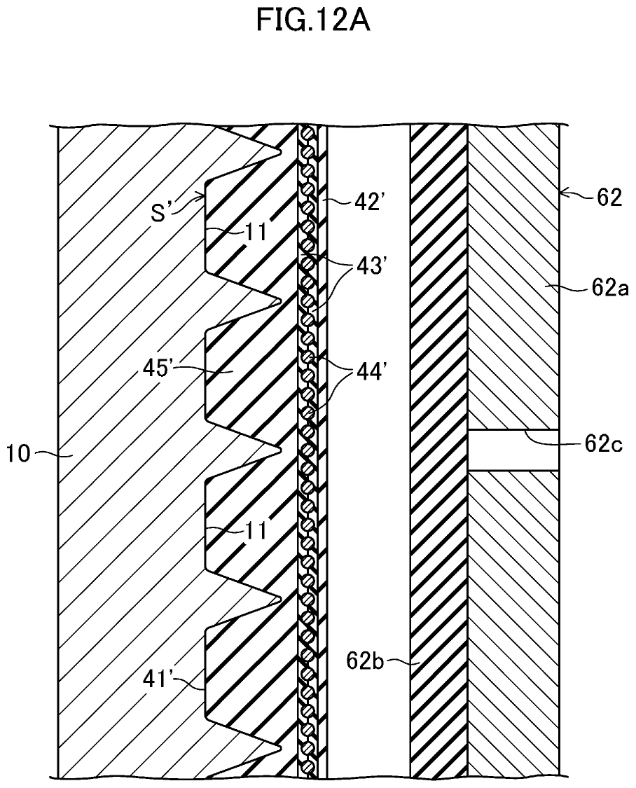

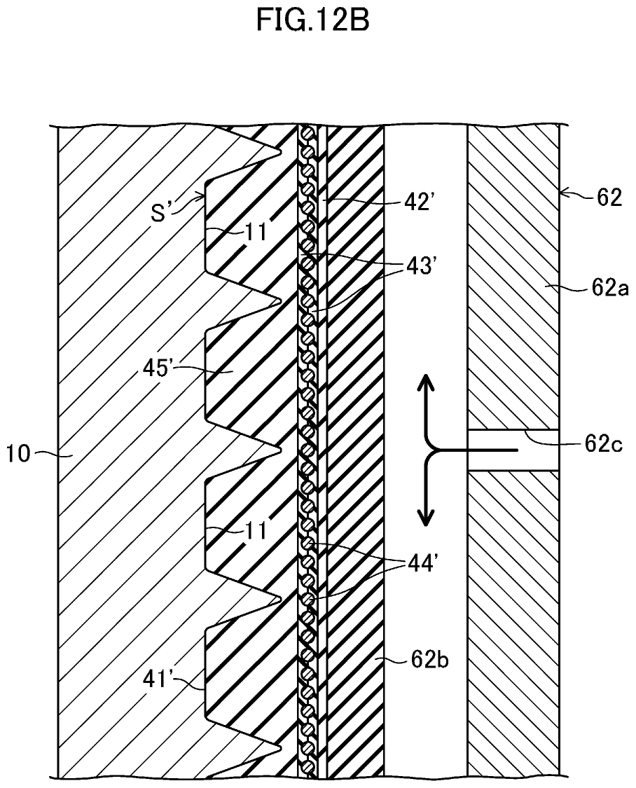

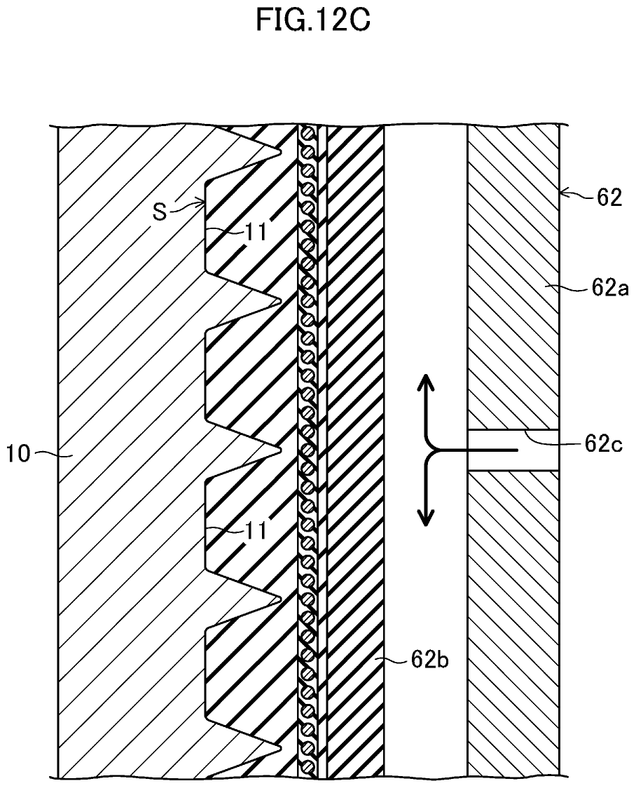

Subsequently, after the expansion member 32 is contracted and removed from the belt mold 10 together with the partition member 31, the belt mold 10 within which the uncrosslinked slab S′ has been set is attached to the base 61 such that the belt mold 10 covers the expansion drum 62 as shown in FIG. 12A.

As shown in FIG. 12B, the temperature of the belt mold 10 is increased by the heating means, and the pressurizing means introduces high-pressure air into the drum body 62a of the expansion drum 62 so as to expand the expansion sleeve 62b radially outward. This state is maintained for a predetermined period of time. At this moment, the uncrosslinked slab S′ is heated by the belt mold 10, and is pressed toward the belt mold 10 by the expansion sleeve 62b. The rubber components contained in the compressed rubber sheet 41′, the stretch rubber sheet 42′, and the adhesive rubber sheet 43′ that are included in the uncrosslinked slab S′ are crosslinked and integrated with one another. As a result, a continuous structure of belt bodies 40 for a plurality of V-ribbed belts B is produced. The rubber components adhere to, and are combined with, the cord 44′. A cylindrical belt slab S is thus formed eventually as shown in FIG. 12C.

<Finishing Step>

In a finishing step, the pressure inside the drum body 62a applied by the pressurizing means is released. After the belt mold 10 is cooled by the cooling means, the belt mold 10 is detached from the base 61, and the belt slab S that has been formed in the belt mold 10 is removed from the belt mold 10. The belt slab S that has been removed from the belt mold 10 is cut into ring-shaped pieces such that one ring-shaped piece corresponds to a predetermined number of V-shaped rib-forming portions 45′. Each piece is turned inside out, thereby obtaining the V-ribbed belt B.

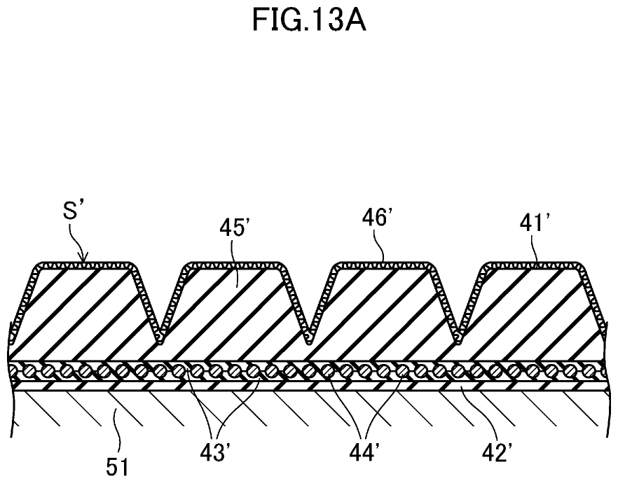

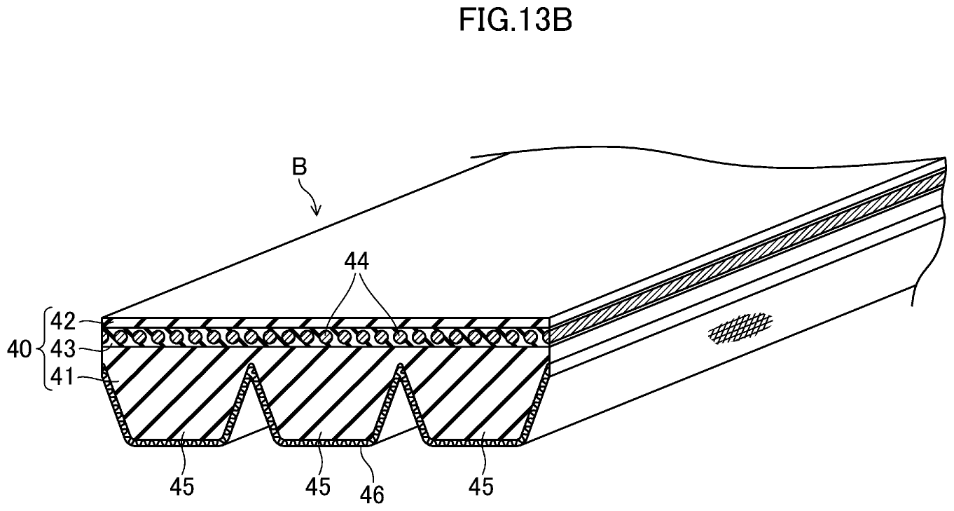

As shown in FIG. 13A, if a reinforcing fabric 46′ that has undergone an adhesion treatment is wrapped around the compressed rubber sheet 41′ along the surfaces of the V-shaped rib-forming portions 45′ to form an uncrosslinked slab S′, a V-ribbed belt B including V-shaped ribs 45 having a surface covered with a reinforcing fabric 46 can be produced as shown in FIG. 13B.

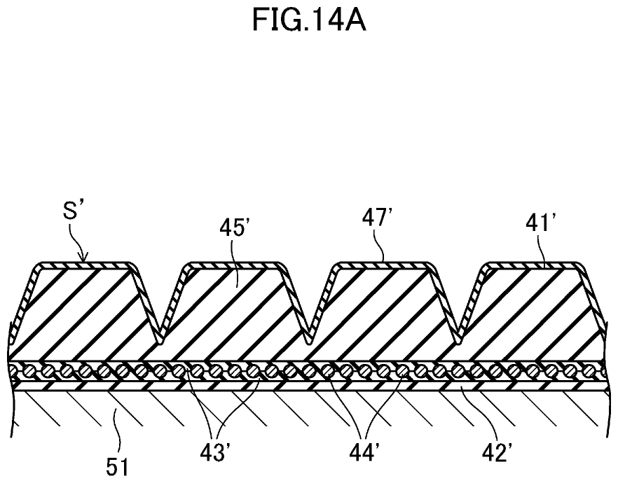

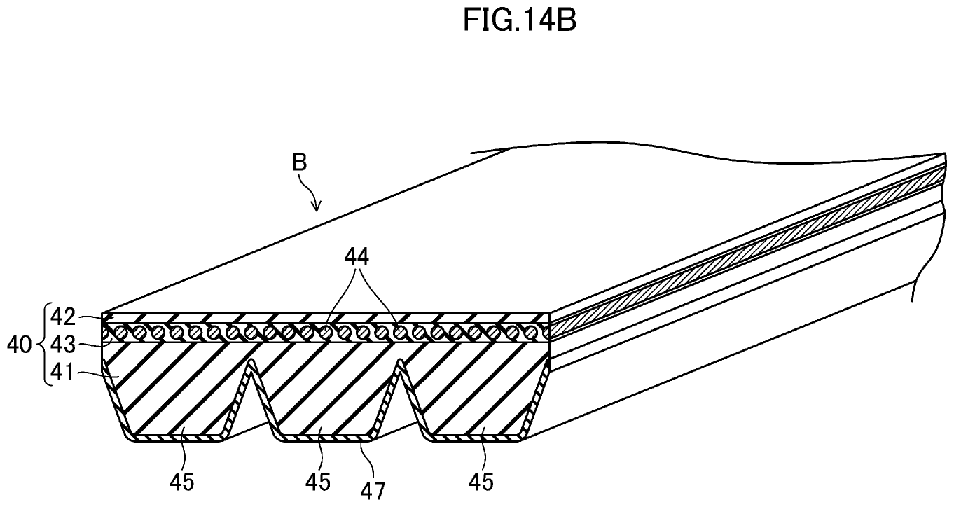

As shown in FIG. 14A, if a surface rubber sheet 47′ made of an uncrosslinked rubber composition different from that of the compressed rubber sheet 41′ is wrapped around the compressed rubber sheet 41′ along the surfaces of the V-shaped rib-forming portions 45′ to form an uncrosslinked slab S′, a V-ribbed belt B including V-shaped ribs 45 having a surface covered with a surface rubber layer 47 can be produced as shown in FIG. 14B.

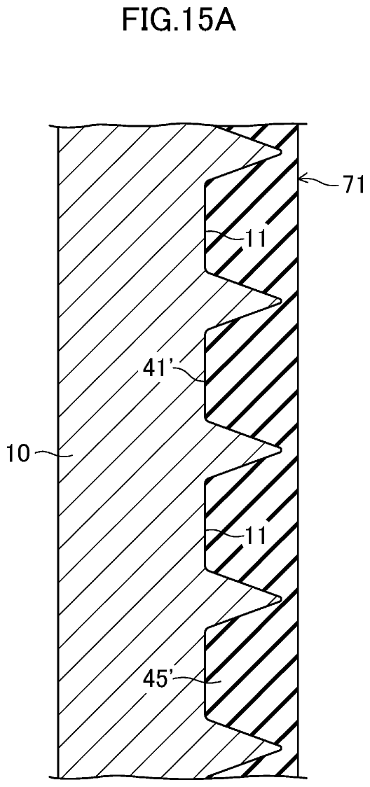

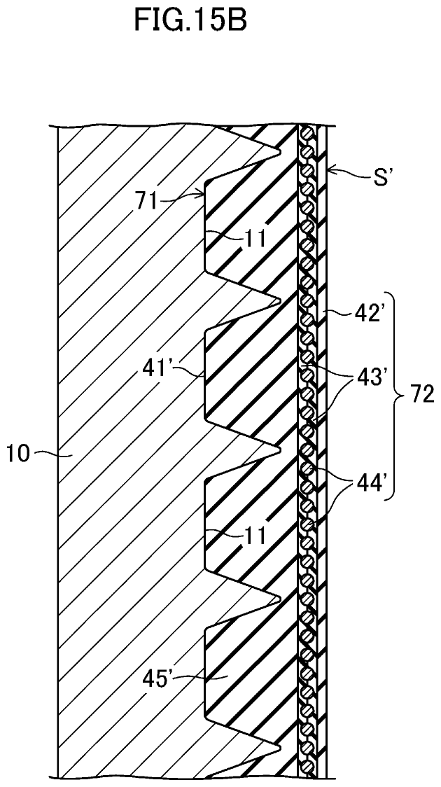

An uncrosslinked slab S′ may be formed inside the belt mold 10 as follows. First, a ribbed, cylindrical rubber 71 configured as a slab constituent member having, on its outer peripheral surface, a plurality of V-shaped rib-forming portions 45′, which are ridges extending in the circumferential direction and arranged adjacent to one another in parallel, is produced from the compressed rubber sheet 41′. In addition to the ribbed, cylindrical rubber 71, a cylindrical rubber tensile member 72 is produced. The cylindrical rubber tensile member 72 includes the stretch rubber sheet 42′, the adhesive rubber sheet 43′, the cord 44′, and another adhesive rubber sheet 43′, which are sequentially stacked and integrated together. As shown in FIG. 15A, the ribbed, cylindrical rubber 71 is first placed inside the belt mold 10. Then, as shown in FIG. 15B, the cylindrical rubber tensile member 72 is placed on the inner surface of the ribbed, cylindrical rubber 71 to form an uncrosslinked slab S′.

At this moment, in placing the ribbed, cylindrical rubber 71 inside the belt mold 10, the ribbed, cylindrical rubber 71 is used as the uncrosslinked rubber shaped structure 20. As shown in FIGS. 1A and 1B to FIGS. 5A and 5B, the uncrosslinked rubber shaped structure 20 is placed in the belt mold 10, with the uncrosslinked rubber shaped structure 20 having the bent portion 21 that is bent inward. Further, the space inside the uncrosslinked rubber shaped structure 20 is partitioned into the first space 22a and the second space 22b. The first space 22a corresponds to the first shaped structure portion 20a of the uncrosslinked rubber shaped structure 20, the first shaped structure portion 20a including the bent portion 21. The second space 22b corresponds to the second shaped structure portion 20b of the uncrosslinked rubber shaped structure 20 that is a portion of the uncrosslinked rubber shaped structure except the first shaped structure portion 20a. The expansion member 32 is expanded in the second space 22b so that the expansion member 32 presses the second shaped structure portion 20b toward the belt mold 10 and that the uncrosslinked rubber shaped structure 20 is arranged along the entire inner periphery of the belt mold 10.

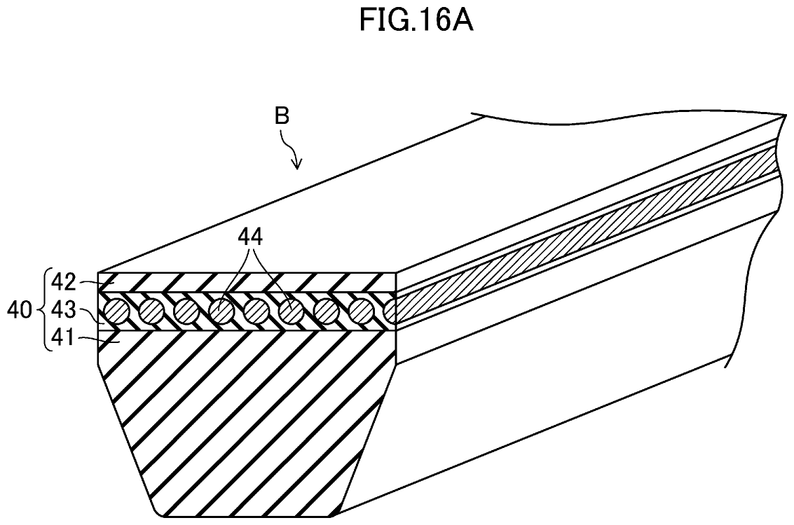

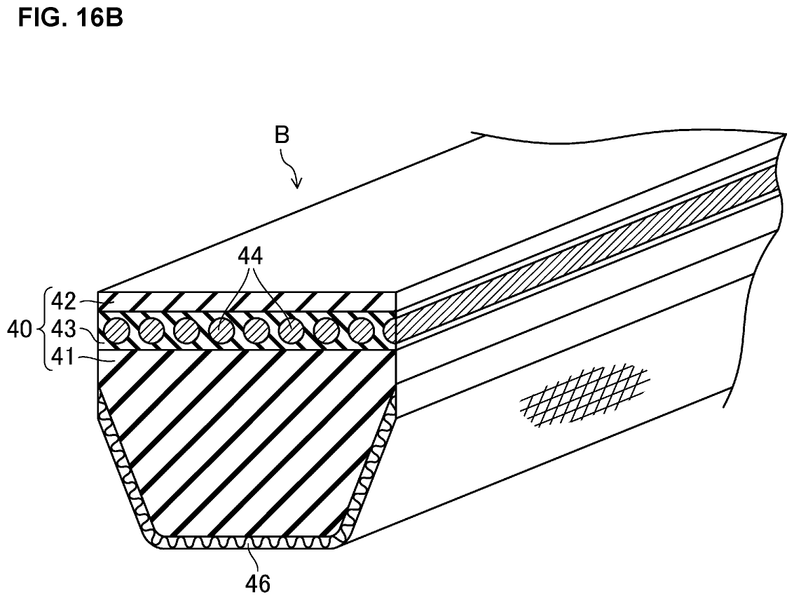

A method similar to the method for producing a V-ribbed belt B using the method for producing a power transmission belt according to this embodiment enables production of a raw edge V-belt B shown in FIG. 16A or a V-belt B shown in FIG. 16B and having a pulley contact surface covered with a reinforcing fabric 46. A toothed belt can also be produced using the method for producing a power transmission belt according to this embodiment.

The embodiments have been described above as example techniques of the present disclosure, in which the attached drawings and the detailed description are provided. As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential. Since the embodiments described above are intended to illustrate the techniques in the present disclosure, it is intended by the following claims to claim any and all modifications, substitutions, additions, and omissions that fall within the proper scope of the claims appropriately interpreted in accordance with the doctrine of equivalents and other applicable judicial doctrines.

What is claimed is:

1. A method for producing a power transmission belt, the method comprising:
a first step of placing, in a cylindrical belt mold, a cylindrical uncrosslinked rubber shaped structure for belt production, with the uncrosslinked rubber shaped structure having a bent portion that is bent inward, and partitioning a space inside the uncrosslinked rubber shaped structure into a first space and a second space, the first space corresponding to a first shaped structure portion of the uncrosslinked rubber shaped structure, the first shaped structure portion including the bent portion, the second space corresponding to a second shaped structure portion of the uncrosslinked rubber shaped structure that is a portion of the uncrosslinked rubber shaped structure except the first shaped structure portion;
a second step of expanding an expansion member in the second space partitioned in the first step, so that the expansion member presses the second shaped structure portion toward the belt mold, and
the partitioning of the space inside the uncrosslinked rubber shaped structure into the first space and the second space in the first step is done by inserting a partition member into the belt mold.

2. The method of claim 1, wherein
the space inside the uncrosslinked rubber shaped structure is partitioned into the first space and the second space such that a length of the first shaped structure portion is shorter than or equal to a length of the second shaped structure portion.

3. The method of claim 1, wherein
the partition member is configured as a flat plate member.

4. The method of claim 1, wherein
after the uncrosslinked rubber shaped structure is placed inside the belt mold, the partition member is inserted into the belt mold.

5. The method of claim 1, wherein
the partition member is provided so as not to be in contact with the uncrosslinked rubber shaped structure.

6. The method of claim 1, wherein
the partition member is in a shape of a flat plate, and clearance between a lateral end of the partition member in the shape of the flat plate and the uncrosslinked rubber shaped structure ranges from 1 mm to 5 mm.

7. The method of claim 1, wherein
the expansion member is configured as a balloon member made of rubber.

8. The method of claim 1, wherein
a difference between an inner peripheral length of the belt mold and an outer peripheral length of the uncrosslinked rubber shaped structure is less than or equal to 0.5% of the outer peripheral length of the uncrosslinked rubber shaped structure.

9. The method of claim 1, wherein
the uncrosslinked rubber shaped structure is an uncrosslinked slab that includes: a cylindrical shaped structure body made of an uncrosslinked rubber composition; and a cord made of aramid fibers, the cord extending so as to form a helical pattern with pitches in an axial direction and embedded in the shaped structure body.
